(19) United States
(12) Patent Application Publication
(10) Pub. No.: US 2025/0087877 A1
(43) Pub. Date: Mar. 13, 2025

(54) Electronic Device with Reconfigurable Antenna Radiation Pattern

(71) Applicant: Apple Inc., Cupertino, CA (US)

(72) Inventors: Simon G. Begashaw, Santa Clara, CA (US); Jiangfeng Wu, San Jose, CA (US); Mei-Li Chi, San Jose, CA (US); Killian J. Poore, San Jose, CA (US); Siwen Yong, San Francisco, CA (US); Yi Jiang, Cupertino, CA (US)

(21) Appl. No.: 18/626,267

(22) Filed: Apr. 3, 2024

Related U.S. Application Data
(60) Provisional application No. 63/581,175, filed on Sep. 7, 2023.

(51) Int. Cl. H01Q 3/24; H01Q 1/27; H04B 17/309

(52) U.S. Cl. CPC H01Q 3/24; H01Q 1/273; H04B 17/309

(57) ABSTRACT

A head-mounted device may have a housing with a cover having three-dimensional curvature. A front-facing display may be mounted to the cover and may display images through the cover. The cover may have a peripheral region laterally surrounding the front-facing display. An antenna may have an antenna resonating element layered onto the cover overlapping the peripheral region. The antenna may be switchable between different radiation patterns. A controller may gather wireless performance metric data for each of the radiation patterns. The antenna may be switched to exhibit a radiation pattern that optimizes the wireless performance metric data. This may serve to minimize interference from external devices operating using the same ultra-low-latency audio communications protocol as the antenna.

This application claims the benefit of U.S. Provisional Patent Application No. 63/581,175, filed Sep. 7, 2023, which is hereby incorporated by reference herein in its entirety.

### FIELD

This relates generally to electronic devices, including electronic devices with wireless communications capabilities.

### BACKGROUND

Electronic devices often have displays that are used to display images to users. Such devices can include head-mounted displays and can have wireless circuitry with antennas. It can be challenging to incorporate antennas that exhibit satisfactory levels of wireless performance into head-mounted displays.

### SUMMARY

A head-mounted device may have a housing. The housing may have an inner conductive chassis mounted to an outer conductive chassis. A logic board may be mounted to the inner conductive chassis. Left and right displays may be mounted to the logic board and may display images at a rear of the device. A cover may be mounted to the outer conductive chassis at the front of the device. The cover may have a compound or three-dimensional curvature. A front-facing display may be mounted to the cover and may display images through the cover. The cover may have a peripheral region laterally surrounding the front-facing display.

The device may have wireless circuitry with an antenna. The antenna may have an antenna resonating element layered onto the cover overlapping the peripheral region. The antenna resonating element may have the compound or three-dimensional curvature. The antenna may include switching circuitry that is adjusted to switch the antenna between different radiation patterns. The device may gather wireless performance metric data using each of the radiation patterns. The antenna may be controlled to exhibit a radiation pattern that optimizes the wireless performance metric data. This may serve to minimize co-channel or adjacent-channel interference from external devices operating using the same ultra-low-latency audio communications protocol as the antenna.

### BRIEF DESCRIPTION OF THE DRAWINGS

FIG. 1 is a schematic diagram of components in an illustrative electronic device in accordance with some embodiments.

FIG. 2 is a cross-sectional top view of an illustrative electronic device in accordance with some embodiments.

FIG. 3 is a schematic diagram of illustrative wireless circuitry having an antenna in accordance with some embodiments.

FIG. 4 is a circuit diagram of illustrative wireless circuitry having a transceiver that communicates with left and right earbuds using a single antenna in accordance with some embodiments.

FIG. 5 is a circuit diagram of illustrative wireless circuitry having a transceiver that communicates with left and right earbuds using respective first and second antennas in accordance with some embodiments.

FIG. 6 is a circuit diagram of illustrative wireless circuitry having a transceiver that conveys the same stream of audio data to left and right earbuds using respective first and second antennas in accordance with some embodiments.

FIG. 7 is a front view of an illustrative electronic device having antennas disposed around the periphery of a cover glass assembly in accordance with some embodiments.

FIG. 8 is a top view of an illustrative electronic device having first and second antennas that are rotated with respect to each other for conveying radio-frequency signals to respective left and right earbuds in accordance with some embodiments.

FIG. 9 is a top view of an illustrative electronic device having first and second antennas with reconfigurable radiation patterns for mitigating interference with nearby devices in accordance with some embodiments.

FIG. 10 is a diagram of an illustrative antenna having a reconfigurable radiation pattern in accordance with some embodiments.

FIG. 11 is a flow chart of illustrative operations involved in conveying audio data between an antenna and an earbud while mitigating interference from nearby devices in accordance with some embodiments.

### DETAILED DESCRIPTION

Electronic devices may be provided with components such as antennas. The electronic devices may include portable electronic devices, wearable devices, desktop devices, embedded systems, and other electronic equipment. Illustrative configurations in which the electronic devices include a head-mounted device may sometimes be described herein as an example. The head-mounted device may have first and second rear-facing displays and a front-facing display. The device may have a housing with a cover at a front side of the device. The cover may have a central region overlapping the front-facing display and a peripheral region surrounding the central region. The cover may have a compound three-dimensional curvature. The device may include an outer conductive chassis and an inner conductive chassis. A main logic board may be mounted to the inner conductive chassis. The first and second rear-facing displays may be mounted to the logic board.

The device may include wireless circuitry with an antenna that radiates through the cover. The antenna may have an antenna resonating element layered onto the cover. The antenna may be switchable between different radiation patterns. Control circuitry may gather wireless performance metric data associated with each of the radiation patterns. The antenna may be switched to exhibit a radiation pattern that optimizes the wireless performance metric data. This may serve to minimize interference from other nearby devices operating using the same ultra-low-latency audio communications protocol as the antenna.

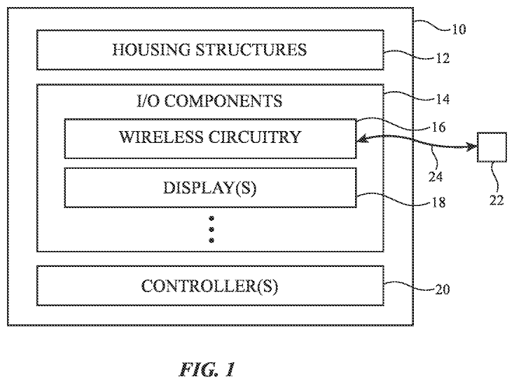

FIG. 1 shows an illustrative electronic device 10. Device 10 may be operated in a system that includes external equipment 22 other than device 10. In some implementations that are described herein as an example, device 10 may include a head-mounted device (sometimes referred to herein as a head-mounted display device or simply a head-mounted display). If desired, device 10 may include a portable electronic device such as a laptop computer, a tablet computer, a media player, a cellular telephone, or a wearable electronic device such as a wristwatch, a pendant or bracelet, headphones, an earpiece, a headset, or other small portable device. Device 10 may also be larger device such as a desktop computer, display with or without an integrated computer, a set-top box, or a wireless access point or base station. If desired, device 10 may be integrated into a larger device or system such as a piece of furniture, a kiosk, a building, or a vehicle.

As shown in FIG. 1, device 10 may include a housing formed from one or more housing structures 12 (sometimes referred to herein as housing members 12). In implementations where device 10 is a head-mounted device, housing structures 12 may include support structures that are mountable or wearable on a user's head (sometimes referred to herein as head-mounted support structures), thereby allowing a user to wear device 10 while using or operating device 10.

The head-mounted support structures in housing structures 12 may have the shape of glasses or goggles and may support one or more lenses that align with one or more of the user's eyes while the user is wearing device 10. The head-mounted support structures in housing structures 12 may include one or more rigid frames that help to provide mechanical integrity, rigidity, and/or strength to device 10 during use. In some implementations that are described herein as an example, the one or more rigid frames are formed from conductive material. The rigid frame(s) may therefore sometimes be referred to herein as conductive frame(s).

If desired, housing structures 12 may include other housing structures or housing members disposed on (e.g., layered on or over, affixed to, etc.) and/or overlapping some or all of the conductive frame(s) (e.g., dielectric structures, rubber structures, ceramic structures, glass structures, fiber composite structures, foam structures, sapphire structures, plastic structures, cosmetic structures, etc.). These other housing structures may, for example, support one or more components in device 10, may help to protect the components of device 10 from damage or contaminants, may help to allow device 10 to be worn comfortably on the user's head, may help to hide portions of the conductive frame from view, may contribute to the cosmetic or aesthetic appearance of device 10, etc.

Device 10 may include input/output (I/O) components such as I/O components 14. I/O components 14 may allow device 10 to provide output and/or other information to the user of device 10 or other entities and/or may allow device 10 to receive user input and/or other information from the user and/or other entities. I/O components 14 may include one or more displays such as displays 18. Displays 18 may emit light (sometimes referred to herein as image light) that is provided to the user's eyes for viewing. The light may contain images. The images may contain image pixels. Many images may be provided over time in a sequence (e.g., as a video). The displays 18 in device 10 may include, for example, left and right displays. The left display may provide light to a user's left eye whereas the right display may provide light to the user's right eye while the user wears device 10 on their head.

I/O components 14 may also include wireless circuitry such as wireless circuitry 16 (sometimes referred to herein as wireless communication circuitry 16). Wireless circuitry 16 may transmit radio-frequency signals 24 to external equipment 22 and/or may receive radio-frequency signals 24 from external equipment 22. External equipment 22 may include another device such as device 10 (e.g., another head-mounted device, a desktop computer, a laptop computer, a cellular telephone, a tablet computer, a tethered computer, etc.), a peripheral device or accessory device (e.g., a user input device, a stylus, a device that identifies user inputs associated with gestures or motions made by a user, a gaming controller, headphones, etc.), remote computing equipment such as a remote server or cloud computing segment, a wireless base station, a wireless access point, and/or any other desired equipment with wireless communications capabilities. In implementations that are described herein as an example, external equipment 22 includes at least first and second peripheral devices such as left and right headphone speakers or earbuds. The earbuds may be worn by a user to provide audio content to the user's ears while the user is wearing device 10 on their head. Wireless circuitry 16 may transmit the audio content to the earbuds using radio-frequency signals 24.

I/O components 14 may also include other components (not shown) such as sensors, haptic output devices (e.g., one or more vibrators), non-display light sources such as light-emitting diodes, audio devices such as speakers for producing audio output, wireless charging circuitry for receiving wireless power for charging a battery on device 10 and/or for transmitting wireless power for charging a battery on other devices, batteries and/or other energy storage devices, buttons, mechanical adjustment components (e.g., components for adjusting one or more housing structures 12 to allow device 10 to be worn comfortably on a user's head and/or on other user's heads, which may have different geometries), and/or other components.

Sensors in I/O components 14 may include image sensors (e.g., one or more visible and/or infrared light cameras, binocular three-dimensional image sensors that gather three-dimensional images using two or more cameras in a binocular configuration, sensors that emit beams of light and that use two-dimensional image sensors to gather image data for three-dimensional images from light spots that are produced when a target is illuminated by the beams, light detection and ranging (lidar) sensors, etc.), acoustic sensors such as microphones or ultrasonic sensors, gaze tracking sensors (e.g., an optical system that emits one or more beams of infrared light that are tracked using the image sensor after reflecting from a user's eyes while wearing device 10), touch sensors, force sensors (e.g., capacitive force sensors, strain gauges, resistive force sensors, etc.), proximity sensors (e.g., capacitive proximity sensors and/or optical proximity sensors), ambient light sensors, contact sensors, pressure sensors, moisture sensors, gas sensors, magnetic sensors, motion sensors for sensing motion, position, and/or orientation (e.g., gyroscopes, accelerometers, compasses, and/or inertial measurement units (IMUs) that include two or more of these), and/or any other desired sensors.

Device 10 may also include one or more controllers 20 (sometimes referred to herein as control circuitry 20). Controller(s) 20 may include processing circuitry and storage circuitry. The processing circuitry may be used to control the operation of device 10 and may include one or more processors such as microprocessors, digital signal processors, microcontrollers, host processors, application specific integrated circuits, baseband processors, graphics processing units, central processing units (CPUs), etc. The storage circuitry in controller(s) 20 may include one or more hard disks or hard drives storage, nonvolatile memory (e.g., electrically-programmable-read-only memory configured to form a solid-state drive), volatile memory (e.g., static or dynamic random-access-memory), etc. If desired, controller(s) 20 may be configured to perform operations in device 10 using hardware (e.g., dedicated hardware or circuitry), firmware, and/or software. Software code for performing operations in device 10 may be stored on storage and may be executed by processing circuitry in controller(s) 20.

Controller(s) 20 run software on device 10 such as one or more software applications, internet browsers, gaming programs, voice-over-internet-protocol (VOIP) telephone call applications, social media applications, driving or navigation applications, email applications, media playback applications, operating system functions, etc. To support interactions with external equipment 22, controller(s) 20 may implement one or more communications protocols associated with (wireless) radio-frequency signals 24. The communications protocols may include internet protocols, wireless local area network protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols, cellular telephone protocols, multiple-input and multiple-output (MIMO) protocols, antenna diversity protocols, satellite navigation system protocols, IEEE 802.15.4 ultra-wideband communications protocols or other ultra-wideband communications protocols, non-Bluetooth protocols for ultra-low-latency audio streaming, etc. Each communications protocol may be associated with a corresponding radio access technology (RAT) that specifies the physical connection methodology used in implementing the protocol.

During operation, wireless circuitry 16 may be used to support communication between device 10 and external equipment 22 (e.g., using radio-frequency signals 24). For example, device 10 and/or external device 22 may transmit video data, application data, audio data, user input commands, and/or other data to each other (e.g., in one or both directions). If desired, device 10 and/or external equipment 22 may use wired and/or wireless communications circuitry to communicate through one or more communications networks (e.g., the internet, local area networks, etc.). If desired, device 10 may communicate with other end hosts over the internet via radio-frequency signals 24 and external equipment 22. Wireless circuitry 16 may allow data to be received by device 10 from external equipment 22 and/or to provide data to external equipment 22.

While controller(s) 20 are shown separately from wireless circuitry 16 for the sake of clarity, wireless circuitry 16 may include processing circuitry and/or storage circuitry that forms part of controller(s) 20 (e.g., portions of controller(s) 20 may be implemented on wireless circuitry 16). As an example, controller(s) 20 may include baseband circuitry (e.g., one or more baseband processors), digital control circuitry, analog control circuitry, and/or other control circuitry that forms part of wireless circuitry 16. The baseband circuitry may, for example, access a communication protocol stack on controller(s) 20 to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

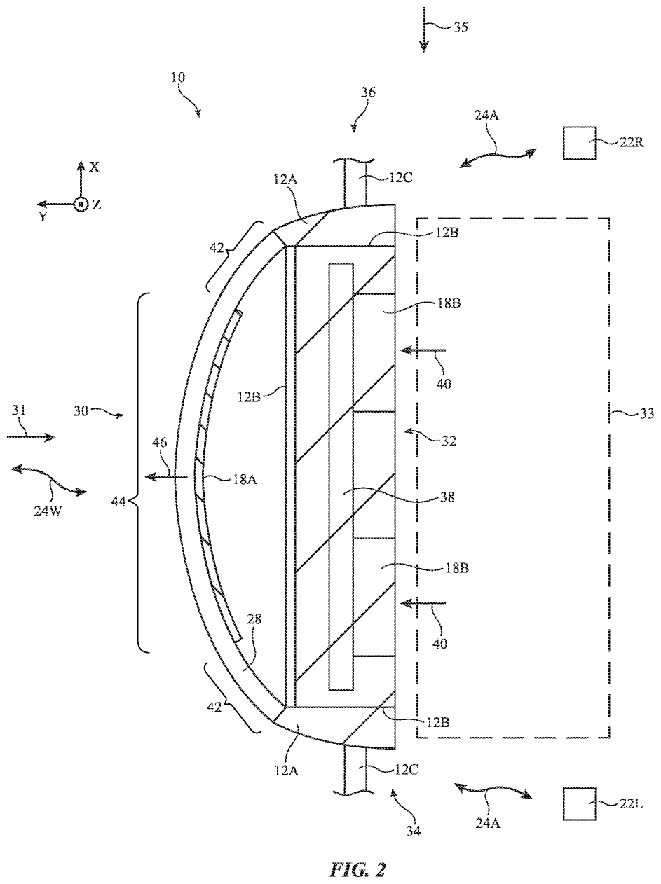

FIG. 2 is a top view of device 10. In the example of FIG. 2, device 10 is a head-mounted device. In general, device 10 may be any suitable electronic equipment. As shown in FIG. 2, device 10 may include housing structures 12. Housing structures 12 may be configured to be worn on a user's head. Housing structures 12 may have curved head-shaped surfaces, a nose-bridge portion that is configured to rest on a user's nose when device 10 is on a user's head, may have a headband such as strap 12C for supporting device 10 on the user's head, and/or may have other features that allow device 10 to be worn by a user.

Housing structures 12 may include one or more frame members such as outer chassis 12A and inner chassis 12B. Outer chassis 12A may be an outer frame surrounding the interior of device 10 and may, if desired, form exterior surfaces of device 10 (e.g., portions of outer chassis 12A may form one or more housing walls of device 10 such as housing walls that run around a periphery of device 10). Inner chassis 12B may be disposed within the interior of device 10 and may be mounted to outer chassis 12A (e.g., outer chassis 12A may surround the lateral periphery of inner chassis 12B in the X-Z plane). Strap 12C may be attached to outer chassis 12A at right side 36 of device 10 and left side 34 of device 10 (e.g., using attachment structures such as a joint, a hinge, screws, fasteners, snaps, magnets, etc.). Strap 12C may be permanently attached to outer chassis 12A or may be removable. Right side 36 may sometimes be referred to herein as right edge 36, right face 36, or right wall 36 of device 10. Left side 34 may extend opposite right side 36 and may sometimes be referred to herein as left edge 34, left face 34, or left wall 34 of device 10. Right side 36 and left side 34 may extend from front side 30 to rear side 32 of device 10.

Outer chassis 12A may be formed from conductive material such as aluminum, stainless steel, or titanium. Outer chassis 12A may therefore sometimes be referred to herein as conductive chassis 12A, conductive outer chassis 12A, outer conductive chassis 12A, conductive outer frame 12A, conductive frame 12A, conductive housing 12A, conductive outer housing 12A, or outer housing 12A. If desired, inner chassis 12B may be formed from a different conductive material than outer chassis 12A (e.g., to meet mounting requirements for the inner chassis, to meet protective requirements for the outer chassis, to meet requirements on mechanical strength and integrity, and minimize device weight). Inner chassis 12B may, for example, be formed from conductive material such as magnesium, aluminum, stainless steel, or titanium. Inner chassis 12B may therefore sometimes be referred to herein as conductive chassis 12B, conductive inner chassis 12B, inner conductive chassis 12B, conductive inner frame 12B, conductive frame 12B, conductive housing 12B, conductive inner housing 12B, inner housing 12B, or conductive support plate 12B.

Outer chassis 12A and inner chassis 12B may provide mechanical support and rigidity for device 10. In addition, one or more components within the interior of device 10 may be mounted or affixed to outer chassis 12A and/or inner chassis 12B. For example, a substrate such as logic board 38 may be mounted to inner chassis 12B. Logic board 38 may, for example, form a main logic board (MLB) for device 10. Other components in device 10 (e.g., portions of I/O components 14 and/or controller(s) 20 of FIG. 1) may be mounted to and/or formed within logic board 38. For example, one or more rear/user facing such as displays 18B may be mounted to logic board 38. Displays 18B may face rear side 32 of device 10. Rear side 32 may sometimes also be referred to herein as rear edge 32, rear wall 32, or rear face 32.

When device 10 is worn on a user's head, the user's head 33 faces rear side 32 of device 10 and the user's eyes are aligned with displays 18B, as shown by arrows 40. Displays 18B may include a left display that aligns with the user's left eye and a right display that aligns with the user's right eye (e.g., the user's left and right eyes may be located within left and right eye boxes of displays 18B). The left and right displays may include respective pixel arrays (or a single shared pixel array) and optics (e.g., one or more lenses) for directing images from the pixel arrays to the user's eyes (e.g., as binocularly fusible content).

The housing structures 12 of device 10 may also include housing structures at the front side 30 of device 10 opposite rear side 32. Front side 30 may sometimes also be referred to herein as front edge 30, front wall 30, or front face 30 of device 10. Housing structures 12 may include a cover glass assembly (CGA) 28 mounted to outer chassis 12A at front side 30 of device 10. CGA 28 may sometimes also be referred to herein as cover 28, front cover 28, or dielectric cover 28 of device 10. CGA 28 may be fully or partially transparent.

CGA 28 may include multiple layers (sometimes referred to herein as cover layers). For example, CGA 28 may include an outer cover layer for device 10 such as a glass cover layer (sometimes referred to herein as a display cover layer or a cover glass). The glass cover layer may form the exterior surface of device 10 at front side 30. CGA 28 may also include one or more dielectric layers behind and overlapping the glass cover layer (e.g., at an interior side of the glass cover layer). The dielectric layer(s) may include one or more polymer layers, plastic layers, glass layers, ceramic layers, and/or other dielectric layers. If desired, some or all of the dielectric layer(s) may be formed in a ring shape that runs along the periphery of CGA 28 in the X-Z plane and the glass cover layer (e.g., at peripheral edge portions 42 of CGA 28) or may overlap substantially all of the glass cover layer. The dielectric layer(s) behind the glass cover layer may sometimes also be referred to as a cover layer, dielectric member, dielectric cover layer, shroud, trim, and/or canopy. Peripheral edge portions 42 may sometimes also be referred to herein as peripheral region 42 or edge region 42.

CGA 28 may also include a forward-facing display such as display 18A (e.g., a flexible display panel formed from a pixel array based on organic light-emitting diodes or other display panel). CGA 28 may have a central portion or region 44 that overlaps display 18A. Peripheral edge portions 42 of CGA 28 may extend around the lateral periphery of CGA 28 and central region 44. Display 18A may emit light (e.g., images) through central region 44 of the dielectric layer(s) and the glass cover layer of CGA 28 (as shown by arrow 46) for view by persons other than the wearer of device 10. The central region 44 of the glass cover layer and the dielectric layer(s) of CGA 28 that overlap display 18A may be fully transparent or partly transparent to help hide display 18A from view when the display is not emitting light. The peripheral edge regions 42 of the glass cover layer and the dielectric layer(s) of CGA 28 may be opaque or transparent. Display 18A may sometimes be referred to herein as a front-facing display, a world-facing display, or a publicly viewable display.

Housing structures 12 may also include cosmetic covering members, polymer layers (e.g., fully or partly transparent polymer layers), and/or dielectric housing walls layered onto or over outer chassis 12A (e.g., at the exterior of device 10) if desired. Housing structures 12 may also include one or more fabric members, rubber members, ceramic members, dielectric members, curtain members, or other structures at rear side 32 of device 10 that help to accommodate the user's face while wearing device 10 and/or to block external, ambient, or scene light from the environment around the user from interfering with or washing out the light from displays 18B being viewed by the user.

Some or all of the lateral surface of CGA 28 may exhibit a curved cross-sectional profile. Within CGA 28, some or all of one or more lateral surfaces of the glass cover layer and/or some or all of one or more of the lateral surfaces of the dielectric layer(s) in CGA 28 may be characterized by a three-dimensional curvature (e.g., spherical curvature, aspherical curvature, freeform curvature, etc.). The three-dimensional curvature may be a compound curvature (e.g., the surfaces exhibiting the curvature may be non-developable surfaces).

In the areas of compound curvature, at least some portions of the curved surface(s) in CGA 28 may be characterized by a radius of curvature R of 4 mm to 250 mm, 8 mm to 200 mm, 10 mm to 150 mm, at least 5 mm, at least 12 mm, at least 16 mm, at least 20 mm, at least 30 mm, less than 200 mm, less than 100 mm, less than 75 mm, less than 55 mm, less than 35 mm, and/or other suitable amount of curvatures. The compound curvature may be, for example, a three-dimensional curvature in which the surface(s) have non-zero radii of curvature about two or more different axes (e.g., non-parallel axes, intersecting axes, non-intersecting axes, perpendicular axes such as the X-axis and Z-axis, etc.) and/or two or more different points within or behind device 10. If desired, one or more of the surfaces of the dielectric layer(s) in CGA 28 may be a developable surface. Display 18A may be a flexible display panel that is bent into a curved shape (e.g., a curved shape following the curved face of a user, a curved shape following the compound curvature of CGA 28, a curved shape characterized by inner and outer developable surfaces, etc.). The compound curvature may serve to provide device 10 with an attractive cosmetic appearance, may help device 10 to exhibit a compact and light weight form factor, may serve to maximize the mechanical strength of device 10, and/or may accommodate easy interaction with device 10 by the user, as examples.

During operation, device 10 may receive image data (e.g., image data for video, still images, etc.) and may present this information on displays 18B and/or 18A. Device 10 may also receive other data, control commands, user input, etc. Device 10 may also transmit data to accessories and other electronic equipment (e.g., external equipment 22 of FIG. 1). For example, image data from a forward-facing camera may be provided to an associated device, audio output may be provided to a device with speakers such as a headphone device, user input and sensor readings may be transmitted to remote equipment, etc.

Communications such as these may be supported using wired and/or wireless communications. In an illustrative configuration, wireless circuitry 16 (FIG. 1) may support wireless communications between device 10 and remote wireless equipment such as external equipment 22 of FIG. 1 (e.g., a cellular telephone, a wireless base station, a computer, headphones or other accessories, a remote control, peer devices, internet servers, and/or other equipment). Wireless communications may be supported using one or more antennas in device 10 and in the external equipment operating at one or more wireless communications frequencies. The antennas may be coupled to wireless transceiver circuitry. The wireless transceiver circuitry may include transmitter circuitry configured to transmit wireless communications signals using the antenna(s) and receiver circuitry configured to receive wireless communications signals using the antenna(s).

External equipment 22 of FIG. 1 may include at least a first accessory or peripheral device 22L and a second accessory or peripheral device 22R, as shown in the example of FIG. 2. Peripheral devices 22R and 22L may, for example, be control input devices (e.g., remote controls, gaming controllers, etc.) or audio output devices such as right and left speakers, right and left speakers of headphones worn by the user, etc. In implementations that are described herein as an example, peripheral device 22R is a right earbud and peripheral device 22L is a left earbud. Peripheral device 22R may therefore sometimes be referred to herein as right earbud 22R and peripheral device 22L may sometimes be referred to herein as left earbud 22L.

While operating device 10, the user wears device 10 on head 33. At the same time, the user wears left earbud 22L on and/or within their left ear (at the left side of head 33) and wears right earbud 22R on and/or within their right ear (at the right side of head 33). Earbuds 22L and 22R may each include a speaker, a battery, one or more processors, and wireless circuitry having one or more antennas. Earbuds 22L and 22R may be wireless earbuds having batteries that are rechargeable when earbuds 22L and 22R are plugged into a power adapter, placed on or within a charging dock, or placed within a charging case, for example.

One or more antennas in device 10 may transmit audio data in radio-frequency signals 24A to earbuds 22R and 22L. Earbuds 22L and 22R may play the audio data over the speakers in earbuds 22L and 22R. The audio data may include a first stream of audio data (e.g., left audio data) for playback by left earbud 22L and a second, different, stream of audio data (e.g., right audio data) for playback by right earbud 22R (e.g., to provide the user with stereo, three-dimensional, spatial, and/or surround sound). One or more antennas in device 10 may also convey other wireless data in radio-frequency signals 24W.

Additionally or alternatively, one or both of earbuds 22L and 22R may include one or more sensors that generate sensor data. The sensors may include a microphone, a touch sensor, a force sensor, an orientation sensor (e.g., a gyroscope, inertial measurement unit, motion sensor, etc.), an ambient light sensor, a proximity sensor, a magnetic sensor, a temperature sensor, and/or other sensors. The microphone may generate microphone data (e.g., voice data from the user speaking while wearing the earbuds). The touch sensor may generate touch sensor data and the force sensor may generate force sensor data (e.g., indicative of a user input provided to device 10 via the earbuds, indicative of the earbuds being presently located in the ears of the user, etc.). The ambient light sensor may generate ambient light sensor data (e.g., indicative of the location of device 10 and/or lighting conditions around the user). In general, the sensors may generate any desired sensor data. Earbuds 22L and 22R may transmit the sensor data to one or more antennas in device 10 using radio-frequency signals 24A and/or using radio-frequency signals 24W.

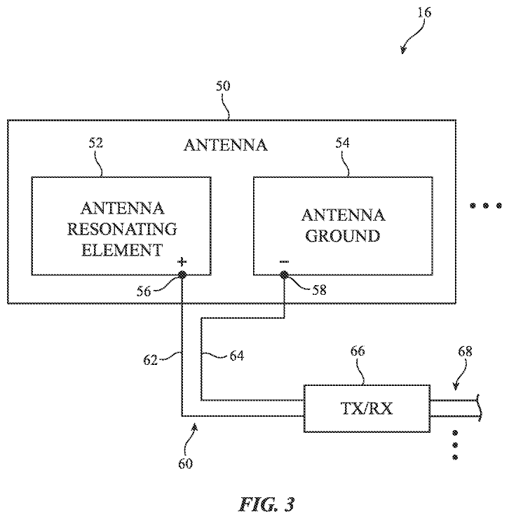

FIG. 3 is a diagram of illustrative components in wireless circuitry 16 of device 10. As shown in FIG. 3, wireless circuitry 16 may include one or more transceivers (e.g., transceiver circuitry) such as transceiver (TX/RX) 66. Transceiver 66 may handle transmission and/or reception of radio-frequency signals 24 (e.g., radio-frequency signals 24A or 24W of FIG. 2) within corresponding frequency bands at radio frequencies (sometimes referred to herein as communications bands or simply as bands).

The frequency bands handled by transceiver 66 may include wireless personal area network (WPAN) frequency bands such as the 2.4 GHz Bluetooth® band or other WPAN communications bands, cellular telephone communications bands such as a cellular low band (600-960 MHz), a cellular low-midband (1400-1550 MHz), a cellular midband (1700-2200 MHz), a cellular high band (2300-2700 MHz), a cellular ultra-high band (3300-5000 MHz), or other cellular communications bands between about 600 MHz and about 5000 MHz), 3G bands, 4G LTE bands, 3GPP 5G New Radio (NR) Frequency Range 1 (FR1) bands below 10 GHz, 3GPP 5G NR Frequency Range 2 (FR2) bands between 20 and 60 GHz, other centimeter or millimeter wave frequency bands between 10-300 GHz, sub-THz or THz bands between around 100-1000 GHz (e.g., 6G bands), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), near-field communications frequency bands (e.g., at 13.56 MHz), satellite navigation frequency bands such as the Global Positioning System (GPS) bands, Global Navigation Satellite System (GLONASS) bands, and BeiDou Navigation Satellite System (BDS) bands, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the family of 3GPP wireless communications standards, communications bands under the IEEE 802.XX family of standards, satellite communications bands, unlicensed bands such as an unlicensed band at 2.4 GHz and/or an unlicensed band between 5-6 GHz, emergency and/or public services bands, and/or any other desired frequency bands of interest. Transceiver 66 may also be used to perform spatial ranging operations if desired (e.g., using a radar sensing scheme).

As shown in FIG. 3, wireless circuitry 16 may also include one or more antennas 50. Transceiver 66 may convey (e.g., transmit and/or receive) radio-frequency signals 24 using one or more antennas 50. Each antenna 50 may include one or more antenna conductors formed from conductive material such as metal. The antenna conductors may include one or more antenna conductors that form antenna resonating element 52 (sometimes referred to as an antenna resonator, an antenna radiator, or an antenna radiating element) and one or more antenna conductors that form antenna ground 54 (sometimes referred to as a ground plane).

Antenna 50 may have an antenna feed coupled between antenna resonating element 52 and antenna ground 54. The antenna feed may have a first (positive or signal) antenna feed terminal 56 coupled to antenna resonating element 52. The antenna feed may also have a second (ground or negative) antenna feed terminal 58 coupled to antenna ground 54. Antenna resonating element 52 may be separated from antenna ground 54 by a dielectric (non-conductive) gap. Antenna resonating element 52 and antenna ground 54 may be formed from separate pieces of metal or other conductive materials or may, if desired, be formed from separate portions of the same integral piece of metal. If desired, antenna 50 may include additional antenna conductors that are not coupled to antenna feed terminals 56 and 58 (e.g., parasitic elements). For some types of antennas (e.g., in implementations where antenna 50 is a slot antenna), the antenna resonating element may be formed from a slot in a single antenna conductor that is coupled to both antenna feed terminals 56 and 58 (e.g., where antenna feed terminals 56 and 58 are coupled to opposing sides of the slot).

Each antenna feed and thus each antenna 50 in wireless circuitry 16 may be coupled to one or more transceivers 66 in wireless circuitry 16 over a corresponding radio-frequency transmission line 60. Radio-frequency transmission line 60 may include a signal conductor such as signal conductor 62 (e.g., a positive signal conductor) and a ground conductor such as ground conductor 64. Ground conductor 64 may be coupled to antenna feed terminal 58 of antenna 50. Signal conductor 62 may be coupled to antenna feed terminal 56 of antenna 50. Radio-frequency transmission line 60 may include one or more of a stripline, microstrip, coaxial cable, coaxial probes, edge-coupled microstrip, edge-coupled stripline, waveguide, radio-frequency connector, combinations of these, etc. Radio-frequency transmission line 60 may also sometimes be referred to herein as a radio-frequency transmission line path. If desired, filter circuitry, tuning components, switching circuitry, impedance matching circuitry, phase shifter circuitry, amplifier circuitry, and/or other circuitry may be disposed on radio-frequency transmission line 60 and/or may be coupled between two or more of the antenna conductors in antenna 50.

The term “convey radio-frequency signals” as used herein means the transmission and/or reception of the radio-frequency signals (e.g., for performing unidirectional and/or bidirectional wireless communications with external wireless communications equipment). During transmission of radio-frequency signals 24, transceiver 66 transmits radio-frequency signals 24 (e.g., as modulated using wireless data such as audio data, control data, etc.) over radio-frequency transmission line 60. The radio-frequency signals may excite antenna currents to flow around the edges of antenna resonating element 52 and antenna ground 54 (via antenna feed terminals 56 and 58). The antenna currents may radiate radio-frequency signals 24 into free space (e.g., based at least on a resonance established by the radiating length of antenna resonating element 52 and/or antenna ground 54).

During the reception of radio-frequency signals 24 (e.g., as modulated by external equipment using wireless data such as voice data, sensor data, image data, etc.), incident radio-frequency signals 24 may excite antenna currents to flow around the edges of antenna resonating element 52 and antenna ground 54. The antenna currents may pass radio-frequency signals 24 to transceiver 66 over radio-frequency transmission line 60. Transceiver 66 may downconvert the radio-frequency signals to baseband and may demodulate wireless data from the signals (e.g., using baseband circuitry such as one or more baseband processors).

Antennas 50 may be formed using any suitable antenna structures. For example, antennas 50 may include antennas with antenna resonating elements that are formed from patch antenna structures (e.g., shorted patch antenna structures), slot antenna structures, loop antenna structures, stacked patch antenna structures, antenna structures having parasitic elements, inverted-F antenna structures, planar inverted-F antenna structures, helical antenna structures, monopole antenna structures, dipole antenna structures, Yagi (Yagi-Uda) antenna structures, surface integrated waveguide structures, hybrids of two or more of these designs, etc. If desired, one or more antennas 50 may be cavity-backed antennas. Antenna 50 may include one or more antenna conductors that form a parasitic antenna resonating element. Whereas antenna resonating element 52 is directly fed (e.g., via positive antenna feed terminal 56), parasitic antenna resonating elements are not directly fed (e.g., are indirectly fed by antenna resonating element 52) and/or serve to modify the radiation pattern and/or radiative characteristics of antenna 50. Two or more antennas 50 may be arranged in a phased antenna array if desired (e.g., for conveying centimeter and/or millimeter wave signals within a signal beam formed in a desired beam pointing direction that may be steered/adjusted over time). Earbuds 22R and 22L may also have wireless circuitry such as wireless circuitry 16 of FIG. 3.

Device 10 may include a first set of one or more antennas that convey radio-frequency signals 24A with earbuds 22R and 22L (FIG. 2). Device 10 may also include a second set of one or more antennas that convey radio-frequency signals 24W with other external equipment 22. Radio-frequency signals 24A may, for example, be conveyed through or towards rear side 32 of device 10, as shown in FIG. 2 (e.g., to and from the expected location of earbuds 22L and 22R while the user wears device 10). Radio-frequency signals 24W may be conveyed through front side 30 of device 10, through rear side 32, and/or through other sides of device 10. Radio-frequency signals 24A may be conveyed using a first radio access technology (RAT), a first communications protocol, a first transceiver in device 10, and/or a first set of frequencies or frequency bands. Radio-frequency signals 24W may be conveyed using a second RAT different from the first RAT, a second communications protocol different from the first communications protocol, a second transceiver in device 10 different from the first transceiver, and/or a second set of frequencies or frequency bands different from the first set of frequencies or frequency bands.

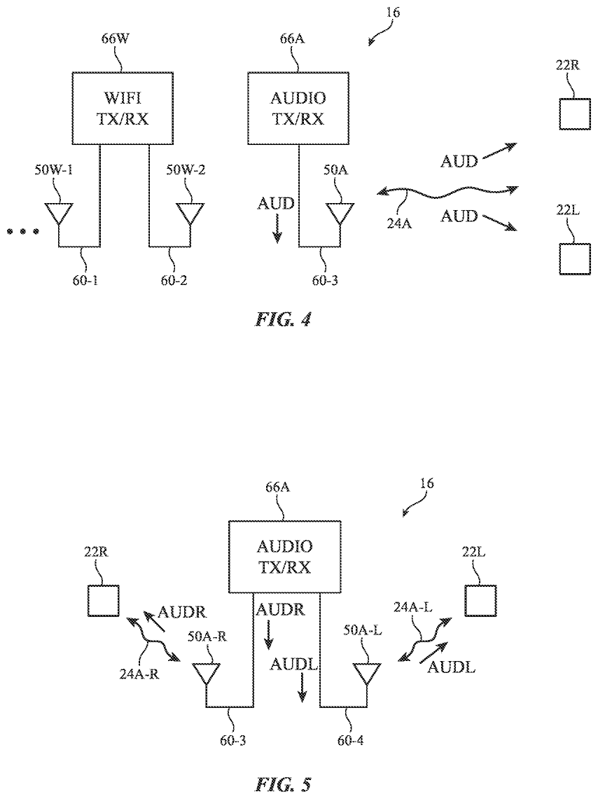

FIG. 4 is a diagram showing how wireless circuitry 16 may include different components for conveying radio-frequency signals 24A and 24W. As shown in FIG. 4, wireless circuitry 16 may use at least one antenna 50A to convey radio-frequency signals 24A and may use at least two antennas 50W (e.g., at least a first antenna 50W-1 and a second antenna 50W-2) to convey radio-frequency signals 24W (FIG. 2). While radio-frequency signals 24A may, in general, convey any desired wireless data between device 10 and multiple peripheral devices, an implementation in which radio-frequency signals 24A convey audio data and sensor data between device 10 and earbuds 22L and 22R is described herein as an example.

Antennas 50W-1 and 50W-2 may be coupled to a first transceiver 66W over radio-frequency transmission lines 60-1, and 60-2, respectively. Antenna 50A may be coupled to a second transceiver 66A over radio-frequency transmission line 60-3. Transceivers 66W and 66A may be formed using different respective radios, modems, chips, integrated circuits, integrated circuit (IC) packages, and/or modules. Transceiver 66W may convey radio-frequency signals 24W (FIG. 2) with external equipment other than earbuds 22R and 22L and/or with earbuds 22R and 22L using antennas 50W-1 and 50W-2. Transceiver 66W may, for example, have respective first and second transmit chains and respective first and second receive chains (e.g., respective first and second ports) coupled to radio-frequency transmission lines 60-1 and 60-2.

Transceiver 66W may convey radio-frequency signals 24W using at least a first communications protocol, at least a first RAT, and a first set of frequency bands. An implementation in which radio-frequency signals 24W include WLAN signals conveyed using a WLAN protocol (e.g., a Wi-Fi protocol), the WLAN RAT, and WLAN frequency bands is described herein as an example. If desired, radio-frequency signals 24W may also include Bluetooth signals conveyed using a Bluetooth protocol and Bluetooth frequency bands.

Transceiver 66W may therefore sometimes be referred to herein as WLAN transceiver 66W, Wi-Fi transceiver 66W, or WLAN/Bluetooth transceiver 66W. Radio-frequency signals 24W may sometimes be referred to herein as WLAN or Wi-Fi signals 24W. This is merely illustrative and, in general, radio-frequency signals 24W may be conveyed using any desired protocol(s).

In some scenarios, Bluetooth signals conveyed by transceiver 66W are used to convey streams of audio data between device 10 and earbuds 22L and 22R. However, Bluetooth signaling can involve an excessive amount of latency and an excessive glitch rate. This can be disruptive to the user experience while listening to audio on earbuds 22L and 22R, particularly for audio data with a relatively high data rate (e.g., as required for immersive, high definition, three-dimensional audio presented to the user along with virtual reality content on displays 18B of FIG. 2). The high latency and excessive glitch rate associated with Bluetooth signaling may be caused by the Bluetooth protocol's requirement for time division duplexing between earbuds 22L and 22R (e.g., where audio data packets are transmitted to right earbud 22R and then to left earbud 22L in a time-alternating manner), frequency hopping between different Bluetooth frequencies, and a relatively large tolerance for packet retransmissions, for example.

To mitigate these issues, transceiver 66A may convey radio-frequency signals 24A using a second communications protocol, a second RAT, and a second set of frequency bands different from those used by transceiver 66W. For example, transceiver 66A may convey radio-frequency signals 24A using a non-Bluetooth, ultra-low-latency audio (ULLA) communications protocol optimized to support low latency and high data rate audio streaming from device 10 to earbuds 22L and 22R. Radio-frequency signals 24A may be conveyed in different frequency bands than radio-frequency signals 24W. For example, radio-frequency signals 24A may be conveyed using an unlicensed band at 2.4 GHz and/or an unlicensed band between 5-6 GHz. The band between 5-6 GHz may allow for a larger bandwidth than the 2.4 GHz band. In addition, the band between 5-6 GHz may allow for fewer coexistence/interference issues than the 2.4 GHz band, which coexists with the Bluetooth band, household appliances such as microwaves that emit around 2.4 GHz, etc.

The ultra-low-latency audio protocol may involve communications without performing time division duplexing between earbuds 22L and 22R and may involve communications with a lower packet re-transmission count limit, lower latency, lower glitch rate (e.g., 1 glitch per hour or fewer), more stability, and less interference than the Bluetooth protocol. Further, the ultra-low-latency audio protocol requires both earbuds 22R and 22L to convey radio-frequency signals 24A directly with device 10 rather than relaying signals or data between earbuds 22R and 2L and has a wireless fading channel selected to have a tighter distribution and shorter tail at the low power end than the Bluetooth protocol. Transceiver 66A may therefore sometimes be referred to herein as audio transceiver 66A. Radio-frequency signals 24A may sometimes be referred to herein as audio signals 24A. The example in which transceiver 66A conveys audio data is merely illustrative and, in general, transceiver 66A may use radio-frequency signals 24A to convey any desired wireless data.

During transmission, transceiver 66A may transmit audio data AUD in radio-frequency signals 24A (e.g., radio-frequency signals 24A may be modulated to carry audio data AUD). Antenna 50A may transmit the radio-frequency signals 24A including audio data AUD. Audio data AUD may include a stream of audio data packets. The stream of audio data packets may include a first set of audio data packets (or any desired first portion of the stream of audio data as distributed across one or more packets) for playback by left earbud 22L (e.g., a stream of left speaker audio data). The stream of audio data packets may also include a second set of audio data packets (or any desired second portion of the stream of audio data as distributed across one or more packets) for playback by right earbud 22R (e.g., a stream of right speaker audio data). The first and second sets may be interspersed or interleaved in time, for example.

Since the ultra-low-latency audio communications protocol governing transmission of radio-frequency signals 24A does not involve time division duplexing (TDD) between earbuds 22R and 22L, the same audio data AUD (e.g., the stream of audio data packets including both left and right speaker audio data) is concurrently (e.g., simultaneously) transmitted to both earbuds 22R and 22L and is concurrently received by both earbuds 22R and 22L. The controllers on earbuds 22R and 22L may demodulate the received audio data to recover the first and second sets of audio data packets. Left earbud 22L may then play the first set of audio data packets without playing (e.g., while discarding) the received second set of audio data packets. Right earbud 22R may play the second set of audio data packets without playing (e.g., while discarding) the received first set of audio data packets. Earbuds 22L and 22R may also transmit radio-frequency signals 24A to antenna 50A on device 10 to confirm/acknowledge receipt of audio data AUD, to convey voice/sensor data to device 10, etc. Since the sensor data gathered by earbuds 22R and 22L may not be subject to the same strict latency requirements as the audio data conveyed by transceiver 66A, earbuds 22L and 22R may, if desired, include additional wireless circuitry that transmits some or all of the sensor data to device 10 using the Bluetooth protocol or other protocols.

In the example of FIG. 4, the same antenna 50A is used to convey radio-frequency signals 24A with both earbuds 22R and 22L. In some situations, using the same antenna 50A to convey radio-frequency signals 24A with both earbuds 22R and 22L can cause an excessive glitch rate due to random transmission nulls and the fading channel between antenna 50A and the earbuds. To improve link quality and glitch rate, wireless circuitry 16 may include different respective antennas 50A for conveying radio-frequency signals 24A with earbuds 22R and 22L, if desired. FIG. 5 is a diagram showing how wireless circuitry 16 may include different respective antennas 50A for conveying radio-frequency signals 24A with earbuds 22R and 22L.

In the example of FIG. 5, transceiver 66W and antennas 50W have been omitted for the sake of clarity. As shown in FIG. 5, wireless circuitry 16 may include at least two antennas 50A such as a first (left) antenna 50A-L and a second (right) antenna 50A-R. Transceiver 66A may be coupled to antenna 50A-L over radio-frequency transmission line 60-4 and may be coupled to antenna 50A-R over radio-frequency transmission line 60-3. Transceiver 66A may, for example, have respective first and second transmit chains and respective first and second receive chains (e.g., respective first and second ports) coupled to radio-frequency transmission lines 60-3 and 60-4.

The radio-frequency signals 24A conveyed by antenna 50A-L may sometimes be referred to herein as radio-frequency signals 24A-L. The radio-frequency signals 24A conveyed by antenna 50A-R may sometimes be referred to herein as radio-frequency signals 24A-R. During transmission, transceiver 66A may transmit a first (left) stream of audio data AUDL in radio-frequency signals 24A-L. Transceiver 66B may concurrently transmit a second (right) stream of audio data AUDR in radio-frequency signals 24A-R. Antenna 50A-R may transmit radio-frequency signals 24A-R and thus audio data AUDR to earbud 22R. Antenna 50A-L may concurrently transmit radio-frequency signals 24-L and thus audio data AUDL to earbud 22L. Audio data AUDL may include a first stream of audio packets (e.g., a first set of audio packets) for playback by left earbud 22L. Audio data AUDR may include a second stream of audio packets (e.g., a second set of audio packets) for concurrent playback by right earbud 22R.

Earbud 22L may also transmit radio-frequency signals 24A-L to antenna 50A-L on device 10 to confirm/acknowledge receipt of audio data AUDL, to convey voice/sensor data to device 10, etc. Similarly, earbud 22R may also transmit radio-frequency signals 24A-R to antenna 50A-R on device 10 to confirm/acknowledge receipt of audio data AUDR, to convey voice/sensor data to device 10, etc.

Conveying respective audio data streams to earbuds 22R and 22L using separate antennas 50A-R and 50A-L may serve to improve link quality or glitch rate relative to using the same antenna 50A (FIG. 4) to convey a single audio data stream. Antenna 50A-R may, for example, be placed at a first location on device 10 that minimizes path loss and optimizes the wireless channel condition between antenna 50A-R and right earbud 22R. On the other hand, antenna 50A-L may be placed at a second location on device 10 that minimizes path loss and optimizes the wireless channel condition between antenna 50A-L and left earbud 22L. The low-latency-audio protocol may configure the transmission timing of the separate streams of audio data AUDL and AUDR in a manner that minimizes interference between the left and right earbuds.

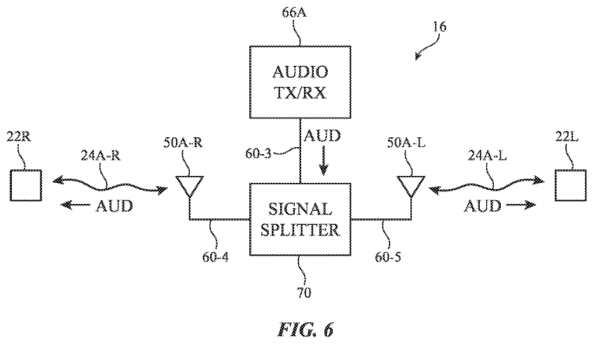

To allow for a simpler low-latency-audio protocol without requiring timing configuration for separate streams of audio data, transceiver 66A may transmit the same stream of audio data AUD over both antennas 50A-R and 50A-L. FIG. 6 is a diagram showing how transceiver 66A may transmit the same stream of audio data AUD over both antennas 50A-R and 50A-L. In the example of FIG. 6, transceiver 66W and antennas 50W have been omitted for the sake of clarity.

As shown in FIG. 6, transceiver 66A may have a single port or transmit/receive chain coupled to radio-frequency transmission line 60-3. The transmit chain may include a power amplifier, switching circuitry, filter circuitry, an analog-to-digital converter, an upconverting mixer, and/or any other desired circuitry associated with the transmission of radio-frequency signals 24A over radio-frequency transmission line 60-3. The receive chain may include a low noise amplifier, switching circuitry, filter circuitry, a digital-to-analog converter, a downconverting mixer, and/or any other desired circuitry associated with the reception of radio-frequency signals 24A over radio-frequency transmission line 60-3.

Wireless circuitry 16 may include a radio-frequency signal splitter/combiner 70 having a first port coupled to radio-frequency transmission line 60-3. Splitter/combiner 70 may have a second port coupled to antenna 50A-R over radio-frequency transmission line 60-4. Splitter/combiner 70 may have a third port coupled to antenna 50A-L over radio-frequency transmission line 60-5. Splitter/combiner 70 may sometimes be referred to herein simply as signal splitter 70 or combiner 70.

During transmission, transceiver 66A may transmit audio data AUD over radio-frequency transmission line 60-3. Splitter/combiner 70 may act as a radio-frequency signal splitter that transmits the same audio data AUD from radio-frequency transmission line 60-3 onto both radio-frequency transmission line 60-4 (in radio-frequency signals 24A-R) and radio-frequency transmission line 60-5 (in radio-frequency signals 24A-L). Antenna 50A-R may transmit the radio-frequency signals 24A-R including audio data AUD. Antenna 50A-L may concurrently transmit the radio-frequency signals 24A-L including the same audio data AUD. For example, antennas 50A-R and 50A-L may concurrently and sequentially transmit each audio packet in the stream of audio packets from audio data AUD (e.g., antennas 50A-R and 50A-L may concurrently or simultaneously transmit a first packet from audio data AUD, may then concurrently or simultaneously transmit a second packet from audio data AUD, may then concurrently or simultaneously transmit a third audio packet from audio data AUD, etc.). Earbuds 22R and 22L may thereby concurrently receive the same stream of audio data AUD, may extract their respective portions of audio data AUD for playback, and may play their respective portions of audio data AUD on the corresponding earbud speakers.

Since the same stream of audio data AUD is transmitted by both antennas 50A-R and 50A-L, there is no concern for interference between radio-frequency signals 24A-R and 24A-L or between earbuds 22L and 22R in this configuration. Earbud 22L may also transmit radio-frequency signals 24A-L to antenna 50A-L on device 10 to confirm/acknowledge receipt of audio data AUDL, to convey voice/sensor data to device 10, etc. Similarly, earbud 22R may also transmit radio-frequency signals 24A-R to antenna 50A-R on device 10 to confirm/acknowledge receipt of audio data AUDR, to convey voice/sensor data to device 10, etc. Splitter/combiner 70 may serve as a radio-frequency combiner that combines the received radio-frequency signals 24A-R from antenna 50A-R and the received radio-frequency signals 24A-L from antenna 50A-L onto radio-frequency transmission line 60-3.

In practice, there may exist a cross-head channel over which earbud 22R receives radio-frequency signals 24A-L transmitted by antenna 50A-L and/or a cross-head channel over which earbud 22L receives radio-frequency signals 24A-R transmitted by antenna 50A-R. In implementations where antennas 50A-L and 50A-R both concurrently transmit the same stream of audio data AUD, the cross-head channels may be used to boost signal reception at earbuds 22R and/or 22L. However, the cross-head channels are usually at least 10 dB lower than the direct wireless channels between left earbud 22L and antenna 50A-L and between right earbud 22R and antenna 50A-R. If desired, wireless circuitry 16 may include a phase shifter (not shown) interposed on radio-frequency transmission line 60-4 between signal splitter 70 and antenna 50A-R or interposed on radio-frequency transmission line 60-5 between signal splitter 70 and antenna 50A-L. The phase shifter may phase shift radio-frequency signals 24A-R relative to radio-frequency signals 24A-L (or vice versa) to boost the cross-head channel, which may further boost signal quality at the earbuds.

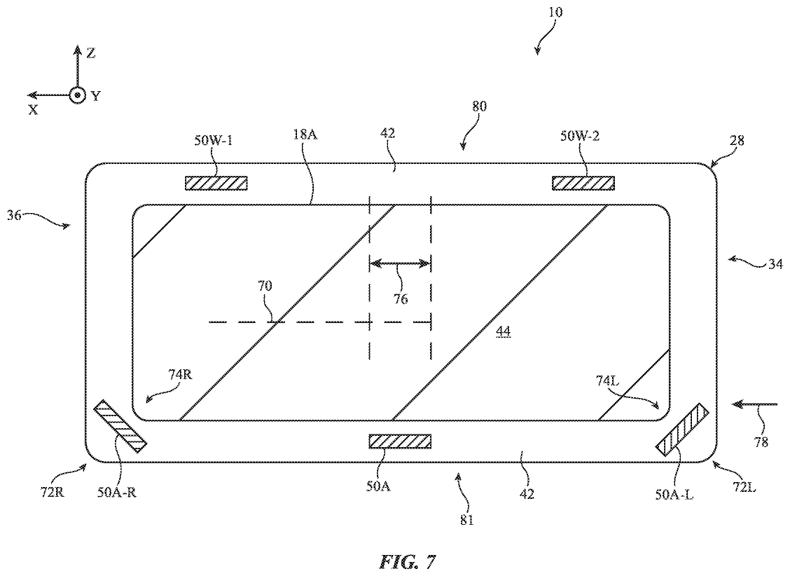

Given the compact and lightweight form factor of device 10 and the presence of conductive structures in device 10 such as outer chassis 12A, inner chassis 12B, conductive portions of logic board 38, displays 18B, and display 18A, it can be challenging to place antennas 50 at locations device 10 that allow the antennas to exhibit satisfactory levels of radio-frequency performance. To help maximize the wireless performance of antennas 50, antennas 50 may be mounted at the front of device 10 and may overlap peripheral edge portions 42 of CGA 28. FIG. 7 is a front view of device 10 (e.g., as viewed in the direction of arrow 31 of FIG. 2) showing how antennas 50 may be mounted at the front of device 10 and overlapping peripheral edge portions 42 of CGA 28.

As shown in FIG. 7, the front-facing display 18A on device 10 may overlap central region 44 of CGA 28 but not peripheral edge portions 42 of CGA 28. Display 18A (central region 44) may be laterally surrounded by peripheral edge portions 42 of CGA 28. In other words, peripheral edge portions 42 may extend around the lateral periphery of display 18A (e.g., when viewed in the X-Z plane). Peripheral edge portions 42 may, for example, form an inactive (conductor-free) portion of CGA 28 that extends around or along the lateral periphery of CGA 28, central region 44 of CGA 28, and display 18A.

Device 10 may have a top side 80 and a bottom side 81 opposite top side 80. Top side 80 may sometimes also be referred to herein as top edge 80, top wall 80, or top face 80 of device 10. Bottom side 81 may sometimes also be referred to herein as bottom edge 81, bottom wall 81, or bottom face 81 of device 10. Right side 36 and left side 34 may extend from top side 80 to bottom side 81 of device 10.

Device 10 may have corners 72 such as a bottom-right corner 72R where right side 36 meets bottom side 81 and a bottom-left corner 72L where left side 34 meets bottom side 81. Display 18A may have corners 74 such as a bottom-right corner 74R facing corner 72R of device 10 and a bottom-left corner 74L facing corner 74L of device 10.

The housing structures of device 10 may have a nose bridge portion such as nose bridge region 85. Nose bridge region 85 may rest on the user's nose while wearing device 10 on their head. Nose bridge region 85 may be laterally interposed between the left and right displays 18B in device 10 (FIG. 2), for example. Nose bridge region 85 may vertically extend from top side 80 to bottom side 81 at the center of device 10.

Display 18A may include pixel circuitry and other conductive components that can block radio-frequency signals conveyed by the antennas in device 10. As such, antennas 50W-1, 50W-2, and one or more antennas 50A may be disposed within device 10 at locations overlapping peripheral edge portions 42 of CGA 28. As shown in FIG. 7, antennas 50W-1 and 50W-2 may be mounted within device 10 and overlapping an upper region or area of peripheral edge portions 42 (e.g., antennas 50W-1 and 50W-2 may be interposed between display 18A and top side 80 of device 10).

Antennas 50W-1 and 50W-2 may convey radio-frequency signals 24W through the dielectric material in CGA 28 and/or the top, bottom, right, left, and/or rear sides of device 10. Antennas 50W-1 and 50W-2 may be disposed at opposing sides of device 10 (e.g., antenna 50W-1 may be disposed at or adjacent right side 36 whereas antenna 50W-2 is disposed at or adjacent left side 34 of device 10) to maximize spatial diversity for transceiver 66W. Antennas 50W-1 and 50W-2 may, for example, be mounted at opposing sides of nose bridge region 85.

The antennas 50A in device 10 may be mounted within device 10 and overlapping a lower region or area of peripheral edge portions 42 (e.g., antenna(s) 50A may be interposed between display 18A and bottom side 81 of device 10). Disposing antenna(s) 50A along the bottom edge of device 10 may serve to minimize the amount of conductive material in device 10 that lies between antenna(s) 50A and the location of earbuds 22R and 22L (FIG. 2) while device 10 is being worn by the user.

In implementations where device 10 includes a single antenna 50A, antenna 50A may convey radio-frequency signals 24A with both earbuds 22R and 22L (FIG. 2) through the dielectric material in CGA 28 and/or the top, bottom, right, left, and/or rear sides of device 10. Antenna 50A may be mounted at or adjacent the center of device 10. For example, antenna 50A may overlap nose bridge portion 85 of device 10 (e.g., antenna 50A may be disposed at the center of device 10 along the X-axis). This may allow antenna 50A to exhibit optimal and balanced channel conditions with both right earbud 22R at right side 36 of device 10 and left earbud 22L at left side 34 of device 10.

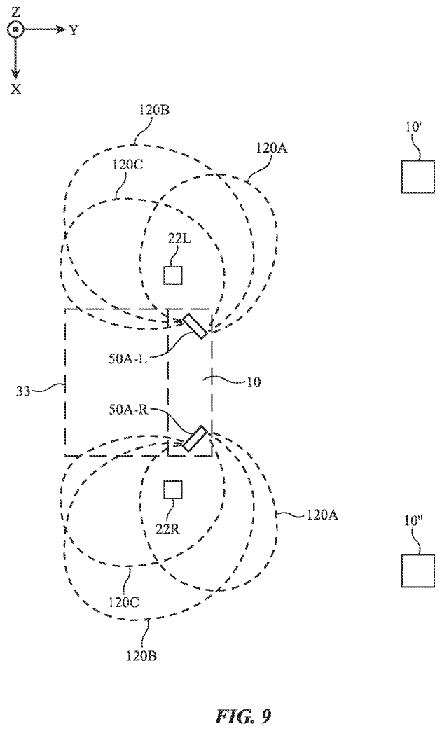

In implementations where device 10 includes multiple antennas 50A such as at least a first antenna 50A-L and a second antenna 50A-R, antenna 50A-R may be mounted at or adjacent to corner 74R of display 18A and/or corner 72R of device 10 (e.g., antenna 50A-R may be laterally interposed between corner 74R of display 18A and corner 72R of device 10). Antenna 50A-L may be mounted at or adjacent to corner 74L of display 18A and/or corner 72L of device 10 (e.g., antenna 50A-L may be laterally interposed between corner 74L of display 18A and corner 72L of device 10). In this way, display 18A may be vertically interposed between the antennas 50W (FIG. 9) and the antenna(s) 50A in device 10, thereby maximizing physical separation and thus isolation between antennas 50W and antenna(s) 50A.

Device 10 may have a central longitudinal axis 70 extending from right side 36 to left side 34 (parallel to the X-axis and perpendicular to nose bridge region 85 of FIG. 9). If desired, antennas 50A-L and 50A-R (e.g., the lateral surfaces of antenna resonating elements 52 (FIG. 3) in antennas 50A-L and 50A-R) may be tilted at non-parallel and non-perpendicular angles with respect to longitudinal axis 70. When placed and oriented in this way, antenna 50A-R may exhibit optimal channel characteristics in conveying radio-frequency signals 24A-R with right earbud 22R (e.g., with minimal blockage by the user's head, display 18A, and/or the other conductive structures of device 10). Similarly, antenna 50A-L may exhibit optimal channel characteristics in conveying radio-frequency signals 24A-R with left earbud 22L (e.g., with minimal blockage by the user's head, display 18A, and/or the other conductive structures of device 10).

The example of FIG. 7 in which antennas 50W and 50A are mounted in device 10 at locations overlapping CGA 28 are merely illustrative. If desired, antennas 50W and/or 50A may be disposed within strap 12C of device 10 and/or at rear side 32 of device 10 (FIG. 2). However, mounting the antenna(s) at rear side 32 of device 10 may subject the antenna(s) to undesirable detuning when displays 18B (FIG. 2) move over time. Mounting the antenna(s) at front side 30 of device 10 may minimize the impact of displays 18B (FIG. 2) on the antenna(s) (e.g., such that movement of displays 18B does not detune the antenna). In addition, mounting the antenna(s) at front side 30 of device 10 may minimize fading channel path loss, may minimize user-to-user variation in the impedance loading of the antennas by the user's head, and may minimize and the amount of radio-frequency energy exposure produced by the antenna(s) on the user's body, helping device 10 to comply with regulatory limits on radio-frequency energy exposure or absorption (e.g., without requiring transmit power level backoffs for the antenna) while meeting the strict latency and glitch rate requirements of the ultra-low-latency audio communications protocol.

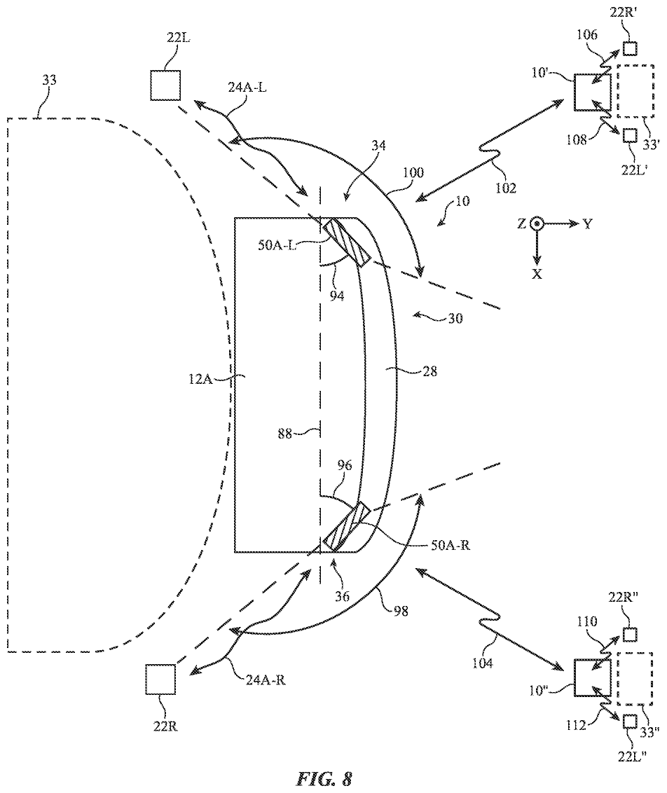

FIG. 8 is a top view showing one example of how antennas 50A-L and 50A-R may be mounted within device 10 at front side 30. As shown in FIG. 8, antenna 50A-L may be mounted within device 10 at, overlapping, and/or within CGA 28 at left side 34 of device 10. Antenna 50A-R may be mounted within device 10 at, overlapping, and/or within CGA 28 at right side 36 of device 10. The antenna resonating elements of antennas 50A-L and 50A-R may, for example, be embedded within, pressed against, and/or layered onto one or more layers (e.g., three-dimensionally curved layers) in CGA 28.

Antenna 50A-R (e.g., the antenna resonating element 52 of antenna 50A-R) may be rotated, tilted, or oriented at a non-parallel and non-perpendicular angle 94 with respect to longitudinal axis 88 of device 10 (e.g., the X-axis of FIG. 14). Antenna 50A-L (e.g., the antenna resonating element 52 of antenna 50A-L) may be rotated, tilted, or oriented at a non-parallel and non-perpendicular angle 96 with respect to longitudinal axis 88.

Antenna 50A-L may exhibit an angular field of view (FOV) 100 (e.g., an angular/spatial region around or facing the antenna resonating element of the antenna in which the antenna exhibits a gain or antenna efficiency that exceeds a threshold gain or antenna efficiency). Similarly, antenna 50A-R may exhibit a FOV 98. Angle 94 may be selected such that the expected location of left earbud 22L lies within FOV 100 of antenna 50A-L. This may allow antenna 50A-L to convey radio-frequency signals 24A-L with left earbud 22L (e.g., while minimizing blockage by outer chassis 12A and/or other conductive components). Similarly, angle 96 may be selected such that the expected location of right earbud 22R lies within FOV 98 of antenna 50A-R. This may allow antenna 50A-R to convey radio-frequency signals 24A-R with right earbud 22R (e.g., while minimizing blockage by outer chassis 12A and/or other conductive components). If desired, the geometry of CGA 28 may be altered to enhance the size of FOV 100 and FOV 98. For example, CGA 28 may exhibit greater curvatures (e.g., greater radii of curvature) within peripheral edge portions 42 than overlapping display 18A to effectively maximize the size of FOV 100 and FOV 98.

If desired, angles 94 and 96 may be selected such that the sum of the magnitudes of angles 94 and 96 (e.g., the relative angle between the surfaces containing the antenna resonating elements 52 of antennas 50A-L and 50A-R) is approximately equal to 90 degrees (e.g., 80-100 degrees, 70-110 degrees, 85-95 degrees, 88-92 degrees, 89-91 degrees, 89.5-90.5 degrees, or other angles around 90 degrees). Put differently, the antenna resonating elements 52 of antennas 50A-L and 50A-R may be oriented at approximately 90 degrees with respect to each other. Angles 94 may, for example, have an equal magnitude to angle 96. Angles 94 and 96 may each have a magnitude of 45 degrees, as one example. This may help to configure antennas 50A-R to convey radio-frequency signals 24A-R with a polarization that is orthogonal to the polarization with which antenna 50A-L conveys radio-frequency signals 24A-L. This may help to minimize destructive interference between radio-frequency signals 24A-R and 24A-L in configurations where radio-frequency signals 24A-R and 24A-L concurrently convey the same stream of audio data AUD to both earbuds 22L and 22R.

The ultra-low-latency audio communications protocol used to convey radio-frequency signals 24A-L and 24A-R may be particularly sensitive to multi-user interference. Multi-user interference poses a challenge to the quality of wireless communications between device 10 and earbuds 22R and 22L when other devices operate in the vicinity of device 10 using the same ultra-low-latency audio communications protocol.

For example, there may be one or more additional devices in the vicinity of device 10 such as devices 10′ and 10″. Devices 10′ and 10″ may be similar devices to device 10 but are operated by different users. For example, a first user may operate device 10 and earbuds 22L and 22R that are paired with device 10 (e.g., while wearing device 10 and earbuds 22L/22R on head 33). At the same time, a second user may operate device 10′ and earbuds 22L′ and 22R′ that are paired with device 10′ (e.g., while wearing device 10′ and earbuds 22L′/22R′ on head 33′). Additional users may also be present, such as a third user operating device 10″ and earbuds 22L″ and 22R″ that are paired with device 10″ (e.g., while wearing device 10″ and earbuds 22L″/22R″ on head 33″).

The antenna(s) on device 10′ may convey radio-frequency signals with earbud 22R′ using the ultra-low-latency audio communications protocol, as shown by arrow 106 (e.g., while device 10 concurrently conveys radio-frequency signals 24A-R with earbud 22R and radio-frequency signals 24A-L with earbud 22L using the ultra-low-latency audio communications protocol). The antenna(s) on device 10′ may concurrently convey radio-frequency signals with earbud 22L′ using the ultra-low-latency audio communications protocol, as shown by arrow 108. The antenna(s) on device 10″ may concurrently convey radio-frequency signals with earbud 22R″ using the ultra-low-latency audio communications protocol, as shown by arrow 110. The antenna(s) on device 10″ may concurrently convey radio-frequency signals with earbud 22L″ using the ultra-low-latency audio communications protocol, as shown by arrow 112.

In practice, at least some of the radio-frequency signals conveyed between device 10′ and earbuds 22L′/22R′ will leak towards or be received by device 10, as shown by arrow 102. Similarly, at least some of the radio-frequency signals conveyed between device 10″ and earbuds 22L″/22R″ will leak towards or be received by device 10, as shown by arrow 104. If care is not taken, the signals from devices 10′ and/or 10″ can potentially interfere with the radio-frequency signals 24A-L and/or 24A-R conveyed between device 10 and earbuds 22L/22R, disrupting audio playback and/or otherwise deteriorating the wireless performance of device 10 and/or earbuds 22L/22R.

Other wireless technologies such as Wi-Fi and cellular telephone communications protocols contain robust mechanisms to coordinate the transmission of radio-frequency signals between multiple users in close vicinity to each other (e.g., multi-user time division duplexing schemes), thereby limiting packet collisions between the users. However, the ultra-low-latency audio communications protocol lacks a mechanism to coordinate across multiple users. For example, the ultra-low-latency audio communications protocol may exhibit stringent latency requirements, a high duty cycle (e.g., around 80%), and may allow for continuous always-on spatial audio to be streamed from device 10 to earbuds 22R/L.

Like the Bluetooth communications protocol, the ultra-low-latency audio communications protocol may include pseudorandom frequency hopping to limit co-channel interference (e.g., where each device 10 hops between different transmit frequencies at different times to minimize the chance that radio-frequency signals from other devices will be received at the same frequency at any given time). However, unlike the Bluetooth communications protocol, the ultra-low-latency audio communications protocol does not include a mechanism to coordinate transmissions between devices. As such, there is still a risk of co-channel interference or adjacent channel interference from devices 10′ and 10″ at device 10 (e.g., when device 10′ or device 10″ transmits audio data at the same time and at the same frequency or an adjacent frequency as device 10). The risk of this interference also depends on the channel conditions between device 10 and the nearby devices. For example, there may be more risk of interference when devices 10′ and 10″ are closer to device 10 than when devices 10′ and 10″ are farther from device 10.

To help mitigate co-channel interference and adjacent channel interference from devices 10′ and 10″, antennas 50A-L and 50A-R on device 10 may have reconfigurable radiation patterns. FIG. 9 is a top view showing how antennas 50A-L and 50A-R may have reconfigurable radiation patterns.

As shown in FIG. 9, antenna 50A-L and 50A-R may each exhibit a set of two or more radiation patterns 120 such as a first radiation pattern 120A, a second radiation pattern 120B, and a third radiation pattern 120C. Radiation patterns 120A-C each have a different spatial shape and/or orientation relative to the corresponding antenna 50A. Radiation pattern 120 corresponds to the spatial curve, line, or contour of constant gain of antenna 50A while transmitting and/or receiving radio-frequency signals. As shown by radiation patterns 120A-C, different radiation patterns have different curves, lines, or contours of constant gain (e.g., having different shapes, oriented in different directions, etc.).

In general, antenna 50A is at greater risk of interference from device 10′ or device 10″ when the radiation pattern of the antenna is oriented towards or overlapping device 10′ or device 10″ than when oriented in other directions away from or non-overlapping with device 10′ or device 10″. For example, when antenna 50A-L is configured to exhibit radiation pattern 120A, antenna 50A-L may be at greater risk of interference from device 10′ than when antenna 50A-L is configured to exhibit radiation pattern 120C (e.g., because radiation pattern 120A is oriented more towards device 10′ than radiation pattern 120C). Similarly, when antenna 50A-R is configured to exhibit radiation pattern 120A, antenna 50A-R may be at greater risk of interference from device 10″ than when antenna 50A-R is configured to exhibit radiation pattern 120C (e.g., because radiation pattern 120A is oriented more towards device 10″ than radiation pattern 120C).

Device 10 may control antennas 50A to update their corresponding radiation patterns 120 over time (e.g., as devices 10′ and 10″ move relative to device 10). Device 10 may independently control antennas 50A-R and 50A-L to exhibit radiation patterns that optimize wireless performance for each antenna at any given time. For example, antenna 50A-L may exhibit radiation pattern 120C while antenna 50A-R exhibits a different radiation pattern such as radiation pattern 120A if that configuration minimizes interference for both antennas 50A-L and 50A-R (e.g., when device 10′ is at a location overlapping radiation pattern 120A whereas device 10″ is at a location overlapping radiation 120C). The radiation patterns may be updated, adjusted, changed, or altered over time.

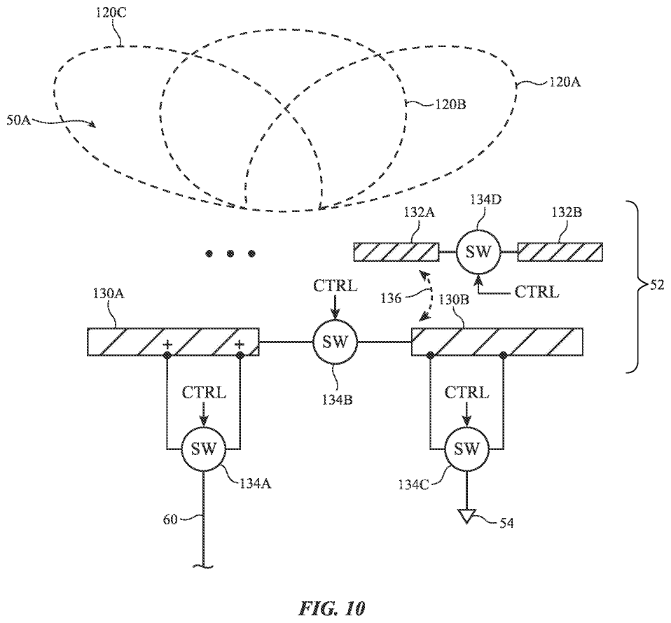

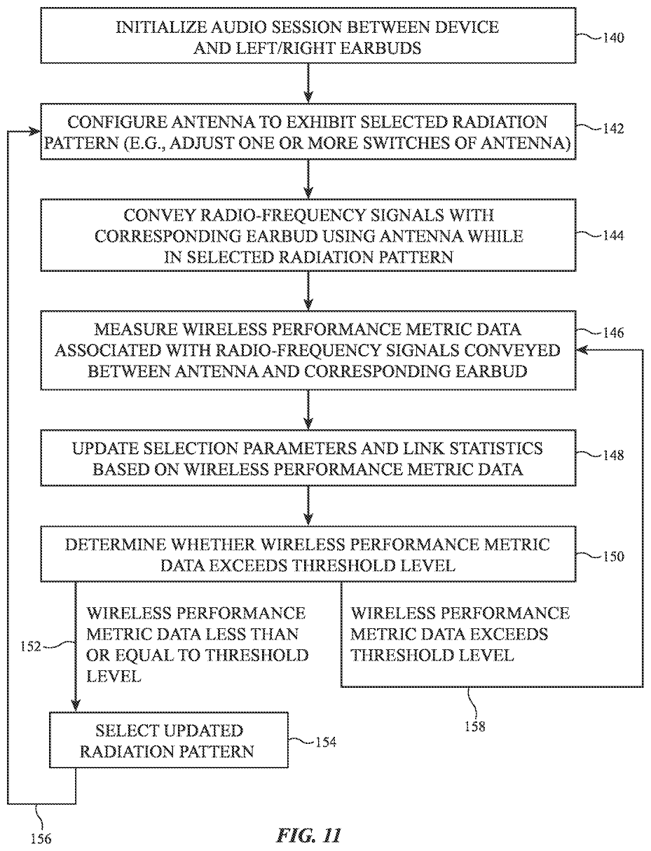

Each antenna 50A may include switching circuitry that is adjusted over time to adjust (reconfigure) the radiation pattern 120 exhibited by that antenna 50A. FIG. 10 is a diagram showing one example of switching circuitry that may be included in antenna 50A for adjusting the radiation pattern 120 of antenna 50A.

As shown in FIG. 10, antenna 50A (e.g., antenna 50A-R or 50A-L of FIG. 9) may include an antenna resonating element 52 and switching circuitry 134. Antenna resonating element 52 may include one or more directly fed conductors 130 (e.g., segments or arms) such as a first directly fed conductor 130A and a second directly fed conductor 130B. If desired, antenna resonating element 52 may include one or more indirectly fed conductors 132 (e.g., parasitic elements or arms) such as a first indirectly fed conductor 132A and a second indirectly fed conductor 132B.

The directly fed conductors 130 in antenna resonating element 52 are coupled to the radio-frequency transmission line 60 for antenna 50A. The indirectly fed conductors 132 in antenna resonating element 52 are not coupled to radio-frequency transmission line 60. Instead, the indirectly fed conductors 132 in antenna resonating element 52 are indirectly fed by one or more directly fed conductors 130 (e.g., via near-field electromagnetic coupling 136) while the directly fed conductor(s) 130 convey antenna currents for radio-frequency transmission line 60. Additionally or alternatively, indirectly fed conductors 132 may effectively perturb the electromagnetic fields produced by directly fed conductors 130, which may serve to alter the radiation pattern of antenna 52.

Switching circuitry 134 may include one or more switches coupled between different points in antenna 50A. The switches may include radio-frequency switches such as radio-frequency switch diodes or other types of switches. Each switch may have a first switch state (sometimes referred to herein as the switch being turned on, active, enabled, or closed) in which the switch forms a closed circuit (e.g., a short circuit impedance, zero impedance, or less than a threshold impedance) between its terminals (e.g., between the different points in antenna 50A). Each switch may have a second switch state (sometimes referred to herein as the switch being turned off, inactive, disabled, or open) in which the switch forms an open circuit (e.g., an open circuit impedance, infinite impedance, or greater than a threshold impedance) between its terminals (e.g., between the different points in antenna 50A). Each switch may receive a respective control signal CTRL that places that switch in a selected one of the first switch state or the second switch state. Different switches in antenna 50A may be in the same switch state at a given time or may be in different switch states at a given time. One or more of the switches may have more than two switch states if desired (e.g., where each switch state couples a different respective impedance between the terminals of the switch and/or antenna ground 54).

For example, as shown in FIG. 10, switching circuitry 134 may include one or more switches 134B coupled between two or more directly fed conductors 130 such as between directly fed conductor 130A and directly fed conductor 130B. Adjusting the state of switch(es) 134B may effectively activate or deactivate one or more directly fed conductors 130 from being used to convey radio-frequency signals (e.g., directly fed conductor 130B may perform a minimal contribution to the radiative response of antenna 50A when switch 134B forms an open circuit and may perform a maximal contribution to the radiative response of antenna 50A when switch 134B forms a short circuit). Antenna current may flow along activated directly fed conductors 130 (e.g., directly fed conductor 130B when switch 134B forms a short circuit impedance). Adjusting switch(es) 134B may, for example, effectively extend or shorten the length of the directly-fed resonating element arm in antenna resonating element 52.

Additionally or alternatively, switching circuitry 134 may include one or more switches 134A coupled between radio-frequency transmission line 60 and different respective points (e.g., positive antenna feed terminals 56 of FIG. 3) on one or more directly fed conductors 130. Adjusting the state of switch(es) 134A may effectively alter the feed point of antenna 50A (e.g., the active positive antenna feed terminal).

Additionally or alternatively, switching circuitry 134 may include one or more switches 134C coupled between one or more points on one or more directly fed conductors 130 and antenna ground 54. Adjusting the state of switch(es) 134C may effectively alter the ground point of antenna 50A (e.g., to form a return path or short circuit path between one or more directly fed conductors 130 and antenna ground 54 or to decouple the one or more directly fed conductors 130 from antenna ground 54).

Additionally or alternatively, switching circuitry 134 may include one or more switches 134D coupled between two or more indirectly fed conductors 132 such as between indirectly fed conductor 132A and indirectly fed conductor 132B. Adjusting the state of switch(es) 134D may effectively activate or deactivate one or more indirectly fed conductors 132 from being used to convey radio-frequency signals (e.g., to lengthen or shorten the length of a parasitic antenna resonating element arm in antenna 50A).

The example of FIG. 10 is merely illustrative. In general, antenna 50A may include a single directly fed conductor 130, may include more than two directly fed conductors 130, may include a single indirectly fed conductor 132, may include no indirectly fed conductors 132, or may include more than two indirectly fed conductors 132. Switch 134D, 134B, 134A, or 134C may be omitted. Switch 134C may be coupled to different points on multiple directly fed conductors 130 and/or may be coupled to one or more points on one or more indirectly fed conductors 132 (e.g., for shorting the directly fed conductor(s) and/or the indirectly fed conductor(s) to antenna ground 54). One or more terminals of switch 134C may be coupled to the same directly fed conductor 130 as radio-frequency transmission line 60 if desired (e.g., directly fed conductor 130A). Switch 134A may be coupled to different points on multiple directly fed conductors 130 if desired. Conductors 130 and 132 may have any desired shapes (e.g., having any desired number of curved and/or straight edges), may extend in any desired directions, and may have any desired lengths. Conductors 130 and/or 132 may configure antenna resonating element to implement any desired antenna architecture (e.g., conductors 130 and/or 132 may form a monopole antenna resonating element, a dipole antenna resonating element, a patch antenna resonating element, a stacked patch antenna resonating element, an inverted-F antenna resonating element, a planar inverted-F antenna resonating element, a loop antenna resonating element, a stripline antenna resonating element, and/or any other desired antenna resonating elements). If desired, conductors 130 and 132 may be replaced with slots in antenna ground 54 (e.g., slot antenna resonating elements in implementations where antenna 50A is a slot antenna). If desired, switching circuitry 134 may configure antenna resonating element 52 to form different types of antenna resonating elements in different switch states.

Controller 20 (FIG. 1) may provide control signals CTRL to one or more of switches 134A, 134B, 134C, and/or 134D to place switching circuitry 134 in a selected one of a set of different switch states. In each switch state, antenna 50A may exhibit a different respective radiation pattern 120. This is because each switch state effectively shifts the antenna current distribution and thus the spatial electric field distribution exhibited by antenna resonating element 52 when conveying radio-frequency signals.

For example, when the switching circuitry is in a first switch state, switches 134A, 134B, 134C, and/or 134D may have a first configuration (e.g., a first combination of individual switch states) that causes the conductors 130 and/or 132 in antenna resonating element 52 to exhibit a first current and electric field distribution, effectively forming radiation pattern 120A when antenna 50A conveys radio-frequency signals. When the switching circuitry is in a second switch state, switches 134A, 134B, 134C, and/or 134D may have a second configuration (e.g., a second combination of individual switch states) that causes the conductors 130 and/or 132 in antenna resonating element 52 to exhibit a second current and electric field distribution, effectively forming radiation pattern 120B when antenna 50A conveys radio-frequency signals. When the switching circuitry is in a third switch state, switches 134A, 134B, 134C, and/or 134D may have a third configuration (e.g., a second combination of individual switch states) that causes the conductors 130 and/or 132 in antenna resonating element 52 to exhibit a third current and electric field distribution, effectively forming radiation pattern 120C when antenna 50A conveys radio-frequency signals. The control circuitry may dynamically adjust switching circuitry 134 over time to change, reconfigure, tweak, alter, re-orient, or adjust radiation pattern 120 over time (e.g., to a radiation pattern 120 that minimizes interference from other devices such as device 10′ and/or device 10″ of FIG. 9).

FIG. 11 is a flow chart of illustrative operations involved in using an antenna 50A (e.g., antenna 50A-L or 50A-R of FIG. 10) to convey radio-frequency signals 24 (e.g., radio-frequency signals containing audio data) with the corresponding earbud 22 (e.g., earbud 22L or 22R of FIG. 8). The operations of FIG. 11 may allow antenna 50A to convey audio data to the corresponding earbud 22 while mitigating co-channel and/or adjacent channel interference from other devices such as device 10′ and device 10″ (FIG. 9) in real time. The operations of FIG. 11 may be repeated and/or performed concurrently for conveying signals between antenna 50A-L and left earbud 22L and between antenna 50A-R and right earbud 22R.

At operation 140, controller 20 may initialize an ultra-low-latency audio communications session between transceiver 66 (FIG. 3) and earbud 22 over antenna 50A. This may, for example, involve transmitting synchronization signals, reference signals, acknowledgement signals, and/or handshake signals between antenna 50A and earbud 22 (e.g., using the corresponding ultra-low-latency audio communications protocol). Operation 140 may be performed when the user puts on earbuds 22, when the user provides a user input or an application provides an application call instructing device 10 to initialize the session, periodically, at a scheduled time, in response to receipt of a request to initialize the session from earbud 22, or in response to any desired trigger condition.

At operation 142, controller 20 may control the switching circuitry 134 in antenna 50A to configure antenna 50A to exhibit a selected radiation pattern 120 (e.g., an initial radiation pattern). For example, controller 20 may provide control signals CTRL that control the state of one or more of switches 134A, 134B, 134C, and 134D of FIG. 10 in a manner that configures antenna 50 to exhibit the selected radiation pattern 120.

At operation 144, transceiver 66 may convey radio-frequency signals 24A with earbud 22 using antenna 50A while the antenna is configured to exhibit the selected radiation pattern 120. Radio-frequency signals 24A may include a corresponding stream of audio data, sensor data, reference signals, and/or any other desired data or signal waveforms. For example, when switching circuitry 134 is in a first state, the antenna currents in antenna resonating element 52 may exhibit a first spatial current distribution, causing antenna 50A to transmit and/or receive radio-frequency signals with radiation pattern 120A. When switching circuitry 134 is in a second state, the antenna currents in antenna resonating element 52 may exhibit a second spatial current distribution, causing antenna 50B to transmit and/or receive radio-frequency signals with radiation pattern 120B. When switching circuitry 134 is in a third state, the antenna currents in antenna resonating element 52 may exhibit a third spatial current distribution, causing antenna 50B to transmit and/or receive radio-frequency signals with radiation pattern 120C, etc. Operations 146-150 may be performed concurrent with operation 144 if desired.

At operation 146 (e.g., while antenna 50A conveys radio-frequency signals 24A with the selected radiation pattern 120), controller 20 may measure (e.g., gather, generate, output, produce, estimate, compute, calculate, identify, etc.) wireless performance metric data associated with the radio-frequency signals conveyed by antenna 50A using the selected radiation pattern 120. The wireless performance metric data may include wireless performance metric data associated with radio-frequency signals 24A received by antenna 50A using the selected radiation pattern 120 (e.g., received power level values, signal to interference plus noise ratio (SINR) values, error rate values, received signal quality values, received signal strength indicator values, error vector magnitude values, signal to noise ratio (SNR) values, noise floor values, receiver sensitivity values, etc.), wireless performance metric data associated with radio-frequency signals 24A transmitted by antenna 50A using the selected radiation pattern 120 (e.g., transmit power level values, adjacent channel leakage ratio values, impedance measurements such as scattering parameter values gathered using a signal coupler disposed along the radio-frequency transmission line for antenna 50A, etc.), wireless performance metric data gathered by earbud 22 in response to radio-frequency signals 24A received at earbud 22 (e.g., where earbud 22 transmits the wireless performance metric data to device 10 in radio-frequency signals 24A), and/or any other desired information characterizing the radio-frequency performance of antenna 50A and/or earbud 22 in conveying radio-frequency signals 24A.

At operation 148, controller 20 may update selection parameters and/or link statistics stored at device 10 based on the gathered wireless performance metric data. For example, controller 20 may maintain a database or table that tracks the wireless performance of antenna 50A-L and/or antenna 50A-R over time. Controller 20 may use the tracked information in determining when and/or how to adjust the radiation pattern of antenna 50A, to adjust a threshold to which the wireless performance metric data is compared, etc. Operation 148 may be omitted if desired.

At operation 150, controller 20 may determine (e.g., detect, identify, calculate, etc.) whether the gathered wireless performance metric data exceeds a threshold level (or is within a predetermined range of acceptable values). If/when the wireless performance metric data is less than or equal to the threshold level (or outside the predetermined range of acceptable values), this may be indicative of co-channel or adjacent channel interference from another device (while antenna 50A exhibits the currently selected radiation pattern) and processing proceeds to operation 154 via path 152.

At operation 154, controller 20 may select a new (updated) radiation pattern 120 for antenna 50A. For example, when antenna 50A exhibited a first radiation pattern 120 during the previous iteration of operations 142-150, controller 20 may control switching circuitry 134 (FIG. 10) to configure antenna 50A to exhibit a second radiation pattern 120 for the next iteration of operations 142-150. Processing subsequently loops back to operation 142 until the wireless performance metric data rises above the threshold level.

If/when the wireless performance metric data is greater than the threshold level (or within the predetermined range of acceptable values), this may be indicative of no co-channel or adjacent channel interference at device 10 (or a minimal amount of interference) using the selected radiation pattern. Processing may then loop from operation 150 back to operation 146 via path 158. Antenna 50A may continue to use the selected radiation pattern 120 that produces satisfactory wireless performance metric data until the wireless performance metric data falls below the threshold level (e.g., due to an external device such as device 10′ or device 10″ of FIG. 9 changing position relative to device 10, the addition or subtraction of devices in the vicinity of device 10, etc.). In this way, device 10 may actively and dynamically adjust the radiation pattern 120 of antenna 50A to ensure that there is as little interference from the radio-frequency signals transmitted by other nearby devices using the ultra-low-latency audio communications protocol, thereby optimizing the performance of device 10 and earbud 22 in conveying radio-frequency signals 24A and thus the quality of the audio data received at earbud 22 and played back to the user.

As a more specific example, operations 146-150 may involve the storing and tracking of wireless performance metric data gathered by antenna 50A across different radiation patterns 120 over time. For example, controller 20 may generate a reward/cost function based on the wireless performance metric data (e.g., SINR values) gathered by antenna 50A across different radiation patterns 120 (e.g., as device 10 iterates through the operations of FIG. 11 over time). At an iteration of operation 154, controller 20 may select the radiation pattern 120 that is most likely to maximize wireless performance (e.g., minimize SINR) given the reward/cost function (e.g., the radiation pattern 120 that maximizes the expected cumulative reward or SINR of the reward/cost function). The reward/cost function may be any desired selection reward metric and may, if desired, be based on link quality and/or other system parameters. Radiation patterns 120 that are directed towards interference sources (e.g., external devices that are nearby and that are transmitting signals using the ultra-low-latency audio protocol) may pick up more interference and thus SINR from the sources than radiation patterns directed away from the interference sources. By periodically monitoring SINR or other wireless performance metric data associated with each radiation pattern 120, controller 20 may maintain and update a ranking of different radiation patterns and may dynamically switch between the different patterns (e.g., in order of rank) in a manner that maximizes received signal quality and avoids interference. This is merely illustrative and, in general, any desired logic or algorithm may be used to update radiation pattern 120.

If desired, the adjustment of radiation pattern 120 (e.g., at each iteration of operation 142) may be performed without adjusting the phase of the radio-frequency signals transmitted to or received by antenna 50A. In other words, antenna 50A may convey radio-frequency signals 24A with the same phase during each iteration of operation 144 (e.g., using each radiation pattern 120). This is unlike antennas implemented in a phased antenna array (e.g., antenna 50A may not be part of a phased antenna array). In phased antenna arrays, multiple antennas in an array are provided with different phase shifts that cause the radio-frequency signals from each antenna to constructively and destructively interfere to produce a signal beam having an envelope with peak gain in a corresponding beam pointing direction. Adjusting switching circuitry 134 (FIG. 10) adjusts the radiation pattern 120 of antenna 50A but does not involve adjusting the phase shift of radio-frequency signals conveyed over radio-frequency transmission line 60 and does not change the beam pointing direction or signal envelope of a phased antenna array.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices such as device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, pLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made by those skilled in the art without departing from the scope and spirit of the described embodiments. The foregoing embodiments may be implemented individually or in any combination.

What is claimed is:

1. An electronic device comprising:
a housing;
first and second displays at a first side of the housing;
a cover layer at a second side of the housing opposite the first side;
a third display overlapping a central region of the cover layer and configured to display images through the central region of the cover layer, the cover layer having a peripheral region surrounding the central region;
an antenna overlapping the peripheral region of the cover layer; and
a transceiver configured to convey radio-frequency signals with an earbud over the antenna while the antenna exhibits a first radiation pattern and while the antenna exhibits a second radiation pattern that is different from the first radiation pattern.

2. The electronic device of claim 1, further comprising:
one or more processors configured to generate wireless performance metric data based on the radio-frequency signals conveyed by the antenna, the one or more processors being configured to switch the antenna between the first radiation pattern and the second radiation pattern based on the wireless performance metric data.

3. The electronic device of claim 2, the one or more processors being further configured to switch the antenna from the first radiation pattern to the second radiation pattern when the wireless performance metric data is less than a threshold value.

4. The electronic device of claim 1, wherein the antenna comprises:
an antenna resonating element; and
switching circuitry configured to switch the antenna between the first radiation pattern and the second radiation pattern by adjusting a current distribution in the antenna resonating element.

5. The electronic device of claim 4, wherein the antenna resonating element comprises a first conductor and a second conductor, the switching circuitry comprising a switch coupled between the first and second conductors.

6. The electronic device of claim 4, wherein the antenna comprises an antenna ground, the switching circuitry comprising a switch coupled between the antenna resonating element and the antenna ground.

7. The electronic device of claim 4, further comprising:
a radio-frequency transmission line, wherein the switching circuitry comprises a switch that couples the radio-frequency transmission line to a first point on the antenna resonating element and a second point on the antenna resonating element that is different from the first point.

8. The electronic device of claim 4, wherein the antenna resonating element comprises a directly fed conductor, a first indirectly fed conductor, and a second indirectly fed conductor, the switching circuitry comprising a switch coupled between the first and second indirectly fed conductors.

9. The electronic device of claim 1, wherein the antenna has an antenna resonating element layered onto the cover layer and the cover layer has a three-dimensionally curved surface.

10. The electronic device of claim 9, wherein the antenna resonating element extends parallel to the three-dimensionally curved surface.

11. The electronic device of claim 1, wherein the transceiver is configured to transmit the audio data using a non-Bluetooth audio communications protocol.

12. A method of operating an electronic device, the method comprising:
transmitting, using an antenna, radio-frequency signals to an earbud while the antenna exhibits a radiation pattern;
generating, using one or more processors, wireless performance metric data based on the radio-frequency signals; and
adjusting, using switching circuitry, the radiation pattern of the antenna based on the wireless performance metric data.

13. The method of claim 12, further comprising:
transmitting, using the antenna, additional radio-frequency signals while the antenna exhibits an additional radiation pattern different from the radiation pattern.

14. The method of claim 13, wherein transmitting the radio-frequency signals comprises transmitting the radio-frequency signals with phase and wherein transmitting the additional radio-frequency signals comprises transmitting the additional radio-frequency signals with the phase.

15. The method of claim 12, wherein adjusting the radiation pattern comprises shifting a current distribution in an antenna resonating element of the antenna.

16. The method of claim 15, wherein adjusting the radiation pattern comprises adjusting a length of the antenna resonating element.

17. The method of claim 15, wherein adjusting the radiation pattern comprises changing a feed location of the antenna resonating element.

18. The method of claim 15, wherein adjusting the radiation pattern comprises coupling the antenna resonating element to an antenna ground.

19. A head-mounted device comprising:
first and second displays configured to display respective left and right images at a rear side of the head-mounted device;
a cover layer at a front side of the head-mounted device;
a third display configured to display an image through the cover layer, the cover layer having a first region that overlaps the third display and a second region that extends around a periphery of the first region;
an antenna resonating element overlapping the second region of the cover layer;
a transceiver coupled to the antenna resonating element and configured to use the antenna resonating element to transmit audio data to an earbud; and
a switch coupled to the antenna resonating element, the switch being configured to mitigate interference between the antenna resonating element and an external device by adjusting a direction of a radiation pattern of the antenna resonating element.

20. The head-mounted device of claim 19, further comprising:
one or more processors configured to generate a cost function associated with the radiation pattern of the antenna resonating element, the one or more processors being configured to control the switch to configure the antenna resonating element to exhibit an updated radiation pattern that minimizes the cost function.
